(19) United States
(12) Patent Application Publication
(10) Pub. No.: US 2023/0058128 A1
(43) Pub. Date: Feb. 23, 2023

(54) REAL-TIME CABLE ASSEMBLY CONFIGURATOR WITH CUSTOM CONNECTORS

(71) Applicant: Molex, LLC, Lisle, IL (US)

(72) Inventors: Scott Connelly, St. Charles, IL (US); Abhilash Bandar, Naperville, IL (US)

(73) Assignee: Molex, LLC, Lisle, IL (US)

(21) Appl. No.: 17/794,745

(22) PCT Filed: Feb. 8, 2021
(86) PCT No.: PCT/IB2021/050986

§ 371 Date: Jul. 22, 2022

Related U.S. Application Data
(60) Provisional application No. 62/972,075, filed on Feb. 10, 2020.

(51) Int. Cl. G06F 30/18; G06F 30/12

(52) U.S. Cl. CPC G06F 30/18; G06F 30/12; G06F 2113/16

(57) ABSTRACT

Aspects of the disclosure generally relate to customizing tangible cable wires with connectors for physical assembly, based on input specifications. More specifically, various aspects of the disclosure relate to validation and automated generation of drawings and three dimensional (3D) models of user configurable cable assemblies. Some aspects may use an automation background application that may efficiently interface the input specifications with a computer aided design application (CAD) that generates the assembly models. The automation background application may filter model parameters, associated with a cable assembly, based on input specifications. The filtered parameters may be used to select parts corresponding to the cable assembly and, based on the selected parts, generate a digital model of the cable assembly in near-real time.

### CROSS-REFERENCE TO RELATED APPLICATIONS

This application claims the benefit of priority to U.S. Provisional Application No. 62/972,075, filed on Feb. 10, 2020, which is herein incorporated by reference in its entirety.

### TECHNICAL FIELD

Aspects described herein generally relate to methods, devices, and systems for customizing tangible cable wires with connectors for physical assembly, and more specifically to validation and automated generation of drawings and three dimensional (3D) models of user configurable cable assemblies.

### BACKGROUND

Cables and cable assemblies are used across a wide range of industries for signal and power transmission purposes. Many enterprises offer services for designing and manufacturing customized cable assemblies. However, existing techniques for enabling a user to configure customized cable assemblies are inefficient and time consuming. A user may provide a rough sketch or a description of requirements for the cable assembly, then an engineer may manually create 3D models and drawings of the cable assembly. In addition to being time intensive, there is a risk that the requirements for the cable assembly were not accurate and/or are incompatible with each other.

Aspects of the disclosure provide efficient and/or flexible technical solutions that address and overcome one or more problems associated with configuration and assembly of cable assemblies with connectors.

### SUMMARY

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized and structural and functional modifications may be made, without departing from the scope of the present disclosure. It is noted that various connections between elements are discussed in the following description. It is noted that these connections are general and, unless specified otherwise, may be direct or indirect, and that the specification is not intended to be limiting in this respect. Implementations may include one or more of the following features.

Methods, devices, and systems are disclosed for generating, in near real-time, a graphical rendering of a cable assembly product on a computer display by filtering and validating the cable assembly product. The method comprises multiple operations that may include receiving, at a server device and from a user client device, a selection of parameters for the cable assembly product. The selection of parameters may be in a character delimited input file. In some embodiments, the selection of parameters indicate one or more of: a computer aided design (CAD) template assembly, connector family selections corresponding to connectors of the cable assembly product, parameters associated with the connectors of the cable assembly product, a cable style selection for the cable assembly product, and/or other characteristics of a cable assembly product. The method may further include a step of executing, by the server device, an automation background thread configured to validate, in near real-time, the selection of parameters. In some embodiments, the automation background thread may perform various operations including, but not limited to: determining a CAD template assembly; filtering table records indicating pre-validated connectors corresponding to a plurality of connector families based on the connector family selections and the cable style selection indicated in the character delimited input file (e.g., to determine filtered table records); scanning the filtered table records to find matched table records that match the parameters associated with the connectors of the cable assembly product; and determining, based on the matched table records, model parameters associated with each connector. The method for generating a graphical rendering of a cable assembly product on a computer display may further include generating, by the server device, based on the CAD template assembly and the model parameters associated with the connectors, a digital model of the cable assembly product; and generating, by the server device and based on the digital model of the cable assembly product, a graphic design file of the cable assembly product to display on the user client device. It will therefore be appreciated that the scope of the disclosure and the appended claims is not limited to the specific, aforementioned embodiments. It is to be understood that other embodiments may be utilized and structural and functional modifications may be made without departing from the scope described herein. Further, the foregoing descriptions describe methods that recite the performance of a number of steps. Unless stated to the contrary, one or more steps within a method may not be required, one or more steps may be performed in a different order than as described, and one or more steps may be formed substantially contemporaneously. Various aspects are capable of other embodiments and of being practiced or being carried out in various different ways.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates an example method for configuration of customized cable assemblies, in accordance with one or more example arrangements;

FIG. 2 illustrates an example method for configuration of customized cable assemblies, in accordance with one or more example arrangements;

FIG. 3 illustrates an example graphical user interface (GUI) for selecting parameters associated with a connector to be used at a first end of a cable assembly, in accordance with one or more example arrangements;

FIG. 4 illustrates an example GUI for selecting parameters associated with a cable associated with the cable assembly, in accordance with one or more example arrangements;

FIG. 5 illustrates an example GUI for selecting parameters associated with a connector to be used at a second end of the cable assembly, in accordance with one or more example arrangements;

FIG. 6 illustrates an example GUI for selecting parameters associated with wiring pinouts of the cable assembly, in accordance with one or more example arrangements;

FIG. 7 illustrates an example GUI for selecting other parameters associated with the cable assembly, in accordance with one or more example arrangements;

FIG. 8 illustrates an example GUI for submitting the cable connector parameters for generation of a cable assembly model, in accordance with one or more example arrangements;

FIG. 9 illustrates an example generation of a three-dimensional (3D) model and two-dimensional (2D) drawings corresponding to the cable assembly, in accordance with one or more example arrangements;

FIG. 10 shows an example computing device, in accordance with one or more example arrangements described herein;

FIG. 11 shows an example system for cable configuration, in accordance with one or more example arrangements;

FIGS. 12A and 12B show example cable assemblies, in accordance with one or more example arrangements;

FIGS. 13A-13H show example GUIs at a user device that may be used to input specifications corresponding to a cable assembly, in accordance with one or more example arrangements;

FIG. 14 shows an example data file as generated by the user device or a web server based on user input via GUIs, in accordance with one or more example arrangements;

FIG. 15 shows an example method for generation of cable assembly models, in accordance with one or more example arrangements;

FIG. 16 shows an example method for determining model parameters associated with a first connector of a cable assembly model, in accordance with one or more example arrangements;

FIG. 17 shows an example method for determining model parameters associated with a second connector of the cable assembly model, in accordance with one or more example arrangements;

FIG. 18 shows details associated with a procedure for determining a pinout configuration associated with the cable assembly model, in accordance with one or more example arrangements;

FIG. 19 shows details associated with a procedure for determining a wiring geometry associated with the cable assembly model, in accordance with one or more example arrangements;

FIG. 20 shows details associated with a procedure for determining a bundling geometry associated with the cable assembly model, in accordance with one or more example arrangements;

FIG. 21 shows an example 2D drawing with an included bill of materials (BOM) table and a wiring chart, in accordance with one or more example arrangements;

FIG. 22 shows an example graphical rendering of a 3D model as generated by a computer aided design (CAD) application based on the cable assembly model, in accordance with one or more example arrangements.

While particular embodiments are illustrated in and described with respect to the preceding drawings, it is envisioned that those skilled in the art after review of the entirety disclosed herein may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and appended drawings. Moreover, although the descriptions herein and the associated drawings describe example embodiments in the context of certain example combinations of elements and/or functions, it should be appreciated that different combinations of elements and/or functions may be provided by alternative embodiments without departing from the scope of the disclosure and the appended claims. It is to be understood that other embodiments may be utilized and structural and functional modifications may be made without departing from the scope described herein. Further, the foregoing descriptions describe methods that recite the performance of a number of steps. Unless stated to the contrary, one or more steps within a method may not be required, one or more steps may be performed in a different order than as described, and one or more steps may be formed substantially contemporaneously. Various aspects are capable of other embodiments and of being practiced or being carried out in various different ways.

### DETAILED DESCRIPTION

Aspects of the disclosure provide efficient and flexible technical solutions that address and overcome problems associated with configuration of cable assemblies. In particular, one or more aspects of the disclosure relate to efficient, automated, and near real-time generation of computer-aided design (CAD) data for cable assemblies based on user input. Although various examples refer to cables, connectors, and cable assemblies, the disclosure is not so limited. Rather, the systems and methods described herein further contemplate configuration and assemblies of wire harnesses and other user-configurable systems. An online, cloud-based tool is contemplated that empowers users, some of whom may be customers, to customize, validate, assembly, and direct shipping of custom-tailored product assemblies in near real-time.

In accordance with various aspects of the disclosure, methods, apparatuses, and systems for configuration of cable assemblies are disclosed. A user may input specifications associated with a cable assembly (e.g., via an online portal). The specifications may be used to generate a data file (e.g., a character delimited file, such as a comma separated value (CSV) file, or a data file corresponding to any other format) that may be accessed by a cable configuration platform. The cable configuration platform may, based on the data file, determine a template file to be used for generation of a 3D model of the cable assembly. The template file may be associated with a computer-aided design (CAD) or computer-aided manufacturing (CAM) application. The cable configuration platform may, based on the data file, determine various parts of the cable assembly (e.g., connectors, cables, etc.) and include the parts in the 3D model. The cable configuration platform may further, based on information in the data file, generate the pinout configuration, wire geometry, bundling model geometry, etc. The cable configuration platform may perform one or more additional operations. For example, the cable configuration platform may export the 3D model, generate 2D drawings based on the 3D model, generate a bill of materials table, generate a wiring chart, etc. As such, various examples herein describe a user interface and associated methods, devices, and/or systems that may be used to generate and deliver the customized cable assemble models and associated information in a time-efficient manner.

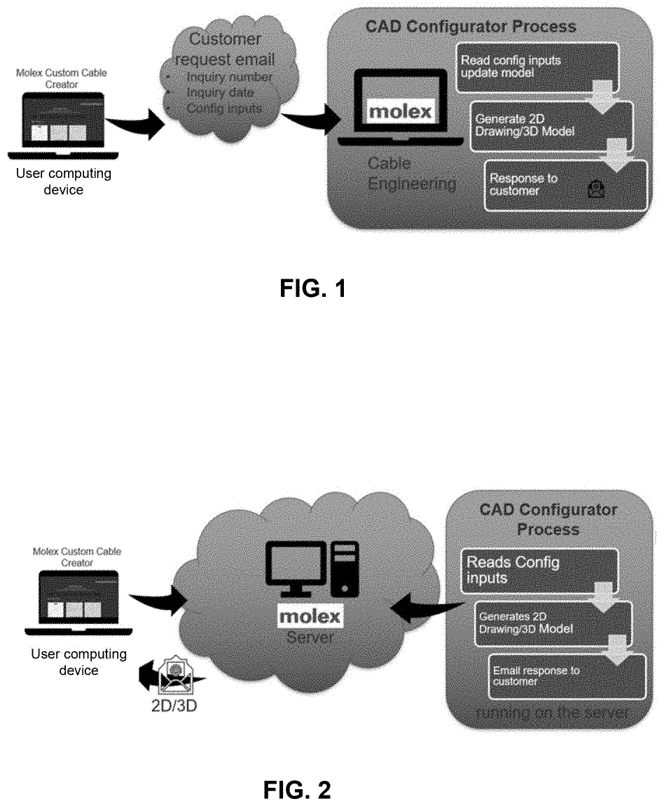

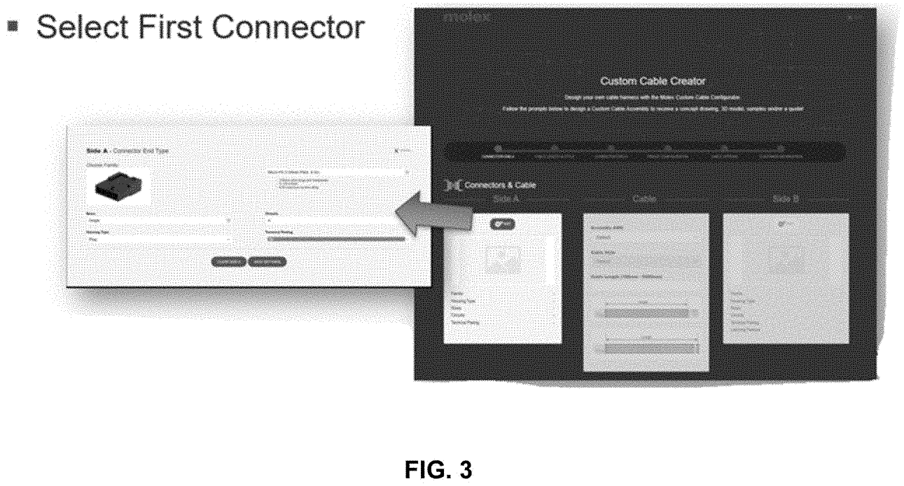

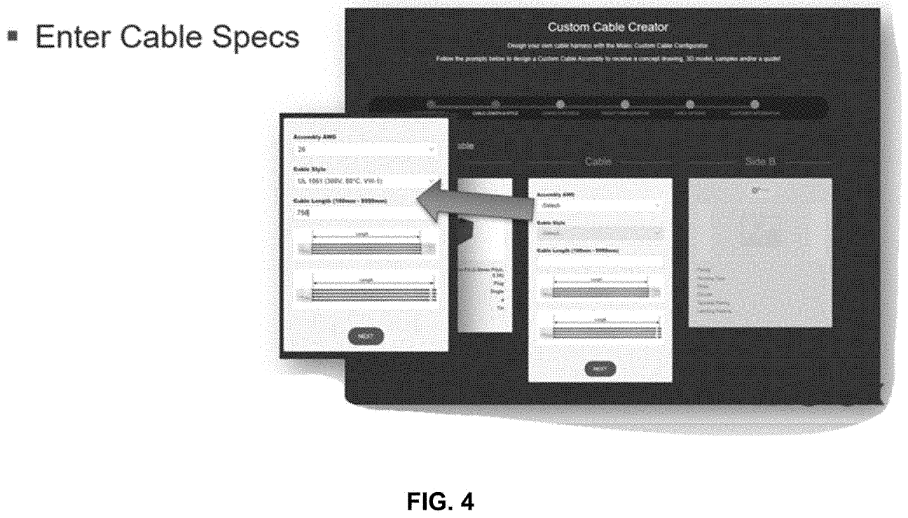

As explained in U.S. Provisional Application No. 62/972,075, to which this application claims the benefit of its priority filing date, FIGS. 1 to 9 show illustrative methods and graphical user interfaces (GUIs) in accordance with one or more embodiments disclosed herein. FIGS. 1 and 2 illustrate two alternative processes for configuration of customized cable assemblies. FIG. 2 illustrates a more automated version of the process as compared to FIG. 1. As shown in FIG. 1, a user device may send configuration inputs corresponding to a cable assembly which may be then used to generate 3D models and drawings of the cable assembly. As shown in FIG. 2, a server may generate 3D models and drawings of a cable assembly based on the configuration inputs. The server may send the generated models and/or drawings to the user device. The configuration inputs may correspond to various specifications that may be input by a user via GUIs as described with reference to FIGS. 3A-3J.

FIGS. 3-7 illustrate screenshots from an interface (e.g., a web interface) that may be used to input, at the user device, specifications associated with the cable assembly. One such step is illustrated in FIG. 3 and involves selecting the type/family of connector to be used at a first end of the cable assembly and further information regarding the connector that is selected (e.g., housing type, number of rows, number of circuits, terminal plating).

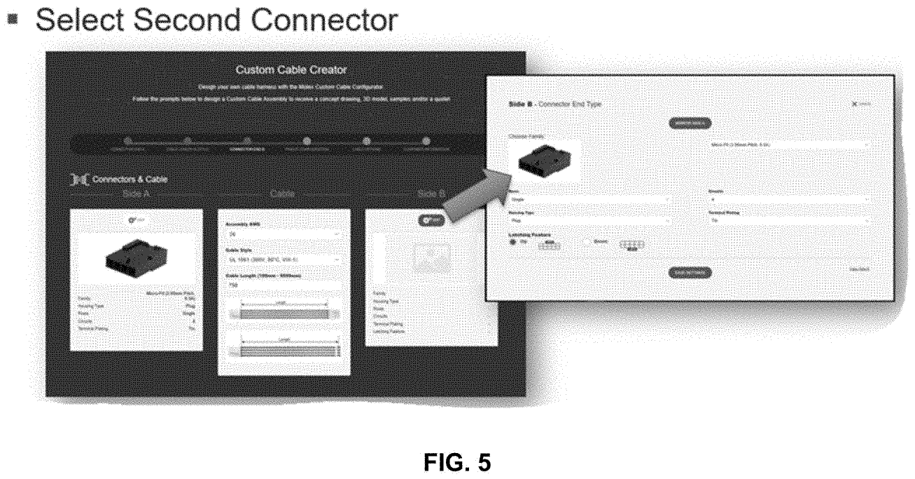

Another such step is illustrated in FIG. 4 and involves selecting, via the interface, information regarding a cable in the cable assembly (e.g., wire gauge (e.g., American wire gauge (AWG), cable style, cable length). Another such step is illustrated in FIG. 5 and involves selecting the type/family of connector to be used at a second end of the cable assembly and further information regarding the connector that is selected (e.g., housing type, number of rows, number of circuits, terminal plating). This step may also allow for a quick selection that mirrors the selection made with regard to the connector to be used at the first end of the cable assembly (as illustrated in FIG. 3).

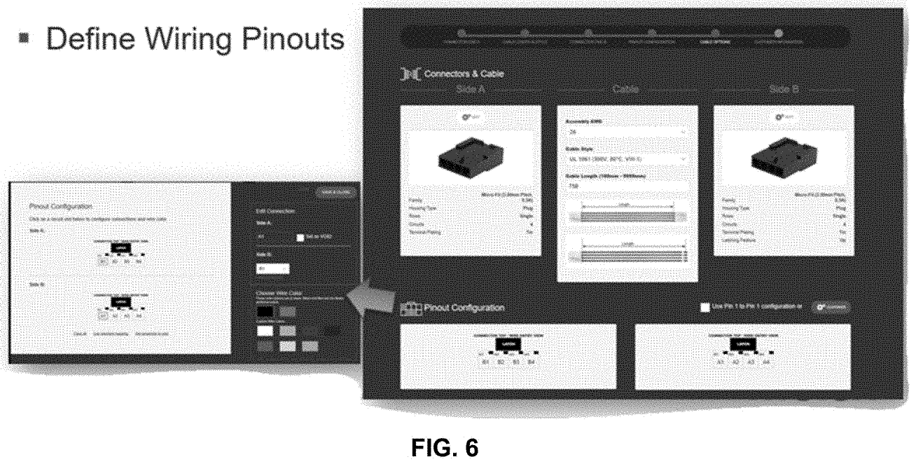

Another such step is illustrated in FIG. 6 (and would typically follow completion of steps illustrated in FIGS. 3-5—which could be performed in any order) and involves selecting/defining the wiring pinouts. The wiring pinouts may define connections between different ports of the connectors and wire colors to be used.

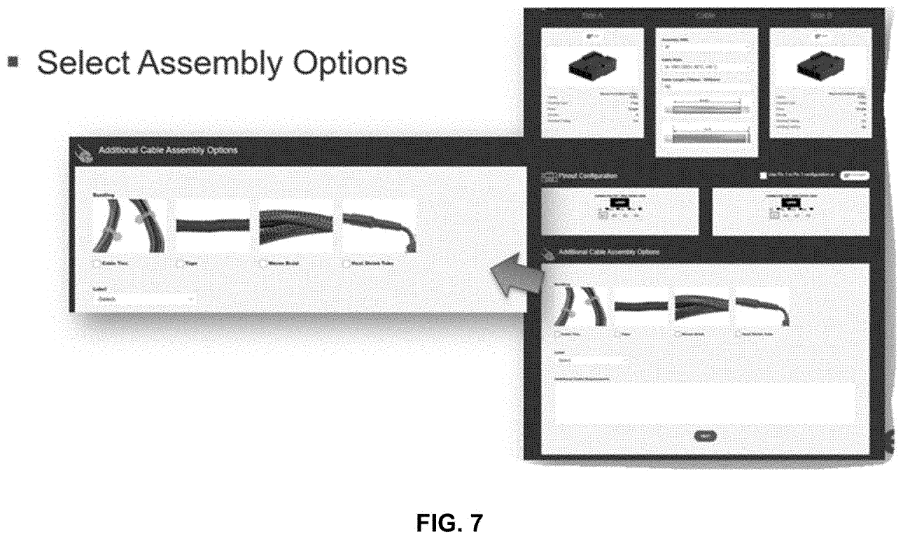

Another such step is illustrated in FIG. 7 and involves selecting the assembly options, including the type of bundling (e.g., cable ties, tape, woven braid, heat shrink tube) to be used for the cable assembly. A label may be applied to the cable assembly, and the interface may enable the user to enter the text to be included in the label. The user may also have the option to add further information regarding the cable assembly.

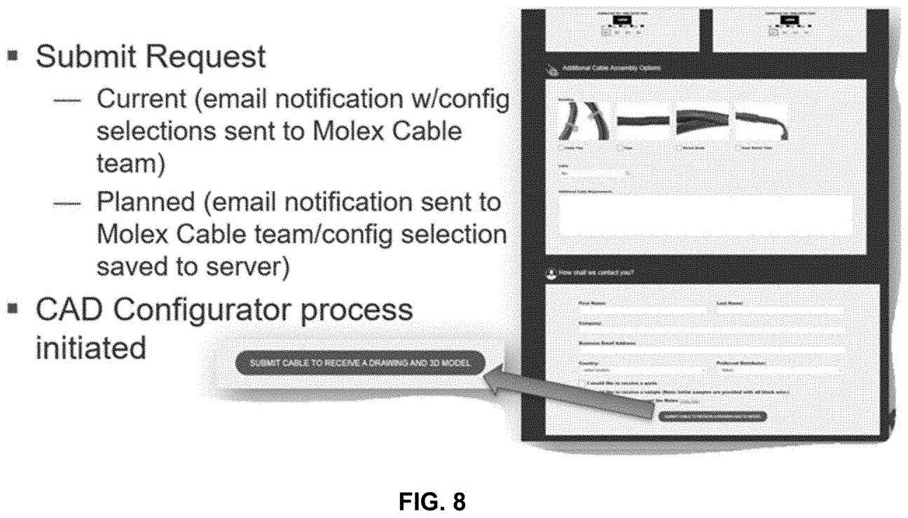

As illustrated in FIG. 8, upon completing the steps illustrated in FIGS. 3-7, the user may submit the request via the interface and the CAD configuration process may be initiated (either by having an e-mail notification with the input cable specifications being sent to a team for manual processing—as illustrated in FIG. 1, or by having an e-mail notification with the input cable specifications being sent to the team and saved to a server for automated processing—as illustrated in FIG. 2).

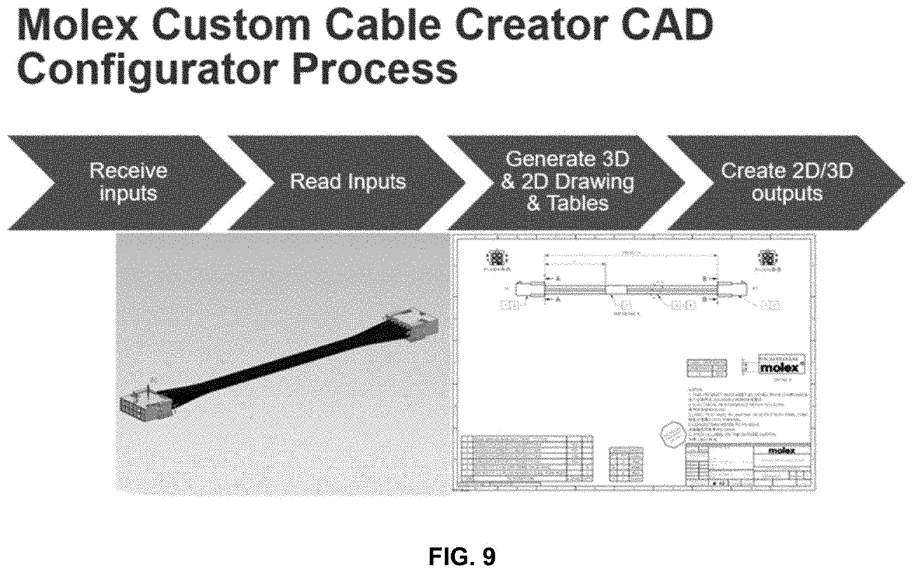

As illustrated in FIG. 9, based on the submitted cable specifications, a 3D model, a 2D drawing and tables may be generated by a CAD/CAM application (e.g., based on automated processing by the server, or based on manual processing by one or more other users). The 3D and 2D drawings and tables may be generated by loading a CAD template which includes a 3D model and/or 2D drawings. Once the CAD template is loaded, the user's cable specifications may be read into the CAD template, thereby updating and generating the 3D models, 2D drawings, and tables (either by manual processing by the team—as illustrated in FIG. 1, or by the saved configuration on the server for more automatic processing—as illustrated in FIG. 2). In contrast to prior methods, the automated processing provides for in near real-time generation of a graphical rendering. In one example, existing 3D models and 2D drawings are modified/updated based on the specifications provided by the user selections collected into a character delimited input file. The 3D and 2D drawings and tables, once completed, may be sent back to the user (e.g., via email, and/or for display on an interface at the user device).

Although the preceding example references a character delimited input file, in some examples, the file may be formatted in other ways—e.g., delimited in other ways, arranged as a name-value pair, or other format. Moreover, the aforementioned generation may occur in near real-time by producing an output without a reasonable amount of time after receiving the final user input into the system. In contrast to prior systems which required manual preparation of 3D models and/or 2D drawings, the system disclosed herein is considered to perform in near real-time because it performs the generation in a nearly fully automated manner. In some examples, a server device may produce an output within seconds of receipt of the input file. In other examples, the server device may queue requests and product an output within several minutes of receipt of the input file. In some examples, a range of less than 15 minutes may be considered to be in near real-time.

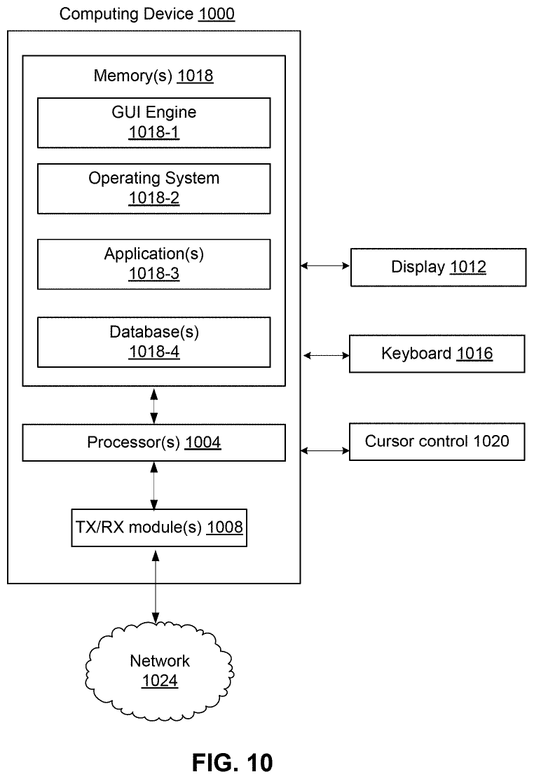

FIG. 10 shows an example computing device 1000 in accordance with one or more example arrangements described herein. The example computing device 1000 may be a user device that may be used to input (e.g., via a user interface) various parameters associated with a cable assembly and generate 3D models, drawings, etc. based on the parameters. The example computing device 1000 may be a desktop computer, laptop computer, a smartphone, a tablet, or any other type of computing device that may be used to communicate with and/or access the various functionalities provided by devices, applications, and/or systems connected to network 1024.

The computing device 1000 may comprise one or more processors 1004 and a memory 1018 (e.g., random access memory (RAM), read-only memory (ROM, etc.). One or more programs/modules stored in the memory 1018, when executed by the processors 1004, cause the computing device 1000 to perform one or more functions described herein. The computer 1000 may be coupled to, and/or integrated with other devices. For example, the computer 1000 may be coupled to, or integrated with, input/output (I/O) devices such as a display device 1012, a keyboard 1016, and/or a cursor control device 1020 (e.g., a mouse, a pointing device, pen and tablet, touch screen, multi-touch device, etc.). Input devices (e.g., the keyboard 1016, cursor control device 1020, etc.) may be used to interact with various GUIs as displayed on the display device 1012. For example, the input devices may be used to input specifications associated with a cable assembly (e.g., as described with reference to FIGS. 3-7).

TX/RX module(s) 1008 may be used to communicate with one or more other devices connected to network 1024. The computing device 1000 may use any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.).

One or more processors (e.g., processor(s) 1004) of the computing device 1000 may be configured to execute machine readable instructions stored in memory 1018. The memory 118 may comprise one or more program modules/engines having instructions that when executed by the one or more processors cause the computing device 1000 to perform one or more functions described herein, and (ii) one or more databases that may store and/or otherwise maintain information which may be used by the one or more program modules/engines and/or one or more processors. The one or more program modules/engines and/or databases may be stored by and/or maintained in different memory units of the computing device 1000 and/or by different computing devices that may form and/or otherwise make up the computing device 1000. For example, the memory 1018 may have, store, and/or comprise a GUI engine 1018-1, an operating system 1018-2, applications 1018-3, and database(s) 1018-4.

In an arrangement, the applications 1018-3 and/or the operating system 1018-2 may accept input and commands and, based on such input and commands and the instructions corresponding to the applications 1018-3 and/or the operating system 1018-2, provide output and results. The applications 1018-3 may comprise CAD/CAM applications (e.g., SIEMENS NX, CATIA, CREO, AUTODESK INVENTOR, SOLIDWORKS, and/or the like) and/or application programming interfaces (APIs) that may be used to modify model files (e.g., associated with the CAD/CAM applications) to generate models of cable assemblies. For example, the APIs may validate the cable assembly specifications and modify, based on the cable assembly specifications input, a template model to generate a model of a requested cable assembly. The cable configuration database 118-2 may store template models, generated models (e.g., associated with various parts that may be used in cable assemblies), etc.

The display 1012 may comprise any type of display, including, but not limited to, liquid crystal display (LCD), light emitting diode (LED), projector, plasma display, cathode ray tube (CRT) display, etc. In one or more arrangements, the display 1012 may be integrated with the computing device 1000. In one or more arrangements, the display 1012 may be a touch-sensitive display that may be used to input information for processing by the computing device 1000.

Various interfaces (e.g., GUIs) may be presented on the display 1012 or provided to another device for presentation, further processing, and/or action. Images/videos (e.g., corresponding to a GUI) to be displayed via the display 1012 may be provided by a graphical user interface (GUI) engine 1018-1. The GUI engine 1018-1 may determine the display images based on data and/or information generated by the operating system 1018-2 and/or applications 1018-3. The GUI engine 1018-1 may further receive user inputs (e.g., as input via input devices such as the keyboard 1018, the cursor control 1020, the touch sensitive display, etc.) and forward this information for processing by the applications 1018-3 and/or store the information to the databases 1018-4.

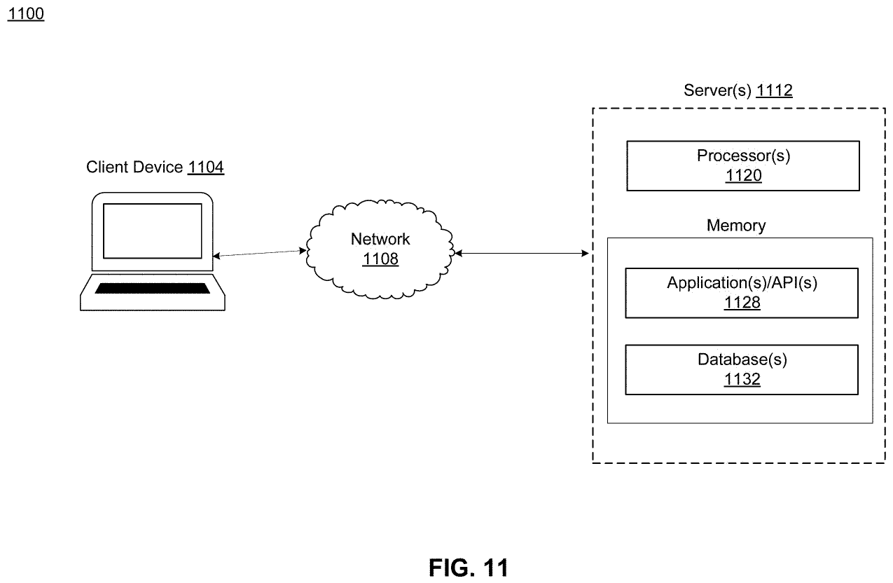

FIG. 11 shows an example system for cable configuration, in accordance with one or more example arrangements. The example system may comprise one or more client devices 1104 connected to one or more servers 1112 via a communication network 1108. The client device 1104 may be similar to the computing device 1000 as described with reference to FIG. 10. For example, the client device 1104 may comprise I/O devices that may be used to interact with a GUI to provide specifications associated with a cable assembly. The servers 1112 may comprise one or more computing devices and/or other computer components (e.g., processors, memories, communication interfaces). As further described herein, the client device 1104 may be used to provide specifications for a cable assembly to the servers 1112, which may subsequently generate 3D models and drawings of the cable assembly as further described herein.

A network 1108 may be used to connect the client device 1104 to server computers 906. The network 1108 may utilize ethernet, coaxial cable, wireless communications, radio frequency (RF), etc. to connect the client device 1104 and servers 1112. The network may utilize any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). The example system of FIG. 11 may correspond to a cloud-based computing system with resources (e.g., storage, processors, applications, memory, infrastructure, etc.) associated with different devices connected via the network 1108 being shared.

The servers 1112 may comprise web servers, application servers, and/or database servers. One or more processors 1120 at the servers 1112 may be configured to execute machine readable instructions stored in memories associated with the servers 1112. The memory may comprise one or more program modules/engines having instructions that when executed by the one or more processors cause the computing device to perform one or more functions described herein, and (ii) one or more databases that may store and/or otherwise maintain information which may be used by the one or more program modules/engines and/or one or more processors. The one or more program modules/engines and/or databases may be stored by and/or maintained in different memory units of the servers 1112 and/or by different computing devices that may form and/or otherwise comprise the servers 1112. For example, the memory may have, store, and/or comprise applications/APIs 1128 and databases 1132.

The applications may comprise CAD/CAM applications (e.g., SIEMENS NX, CATIA, CREO, AUTODESK INVENTOR, SOLIDWORKS, and/or the like) that may be used to generate 3D models and drawings based on specifications provided by the client device 1104. The APIs may be used to modify model files (e.g., associated with the CAD/CAM applications) to generate models of cable assemblies. For example, the APIs may validate the cable assembly specifications and modify, based on the cable assembly specifications input, a template model to generate a model of a requested cable assembly. The databases 1132 may store template models, generated models (e.g., associated with various parts that may be used in cable assemblies), etc.

The client device 1104 may use a web browser to communicate with servers 1112. A web browser may be a program such as MICROSOFT INTERNET EXPLORER/EDGE, MOZILLA FIREFOX, OPERA, APPLE SAFARI, GOOGLE CHROME, etc., and the client device 1104 may communicate with a web server by accessing a uniform resource locator (URL). Alternatively, the client device 1104 may use an application (e.g., installed as a plug-in to the web browser, or as a stand-alone application) to communicate with the servers 1112.

Various instructions implementing the functions of applications, APIs, operating systems, etc. as described with reference to computing device 1000 and/or servers 1112 may be embodied in non-transitory computer-readable media (e.g., fixed or removable data storage devices, such as a zip drive, floppy disc drive, hard drive, CD-ROM drive, tape drive, etc.). In one or more arrangements, the computing device 1000 and/or the servers 1112 may be any type of computing device capable of receiving input via a user interface, and communicating the received input to one or more other computing devices. For example, the computing device 1000 and/or the servers 1112 may, in some instances, be and/or include server computers, desktop computers, laptop computers, tablet computers, smart phones, or the like that may comprised of one or more processors, memories, communication interfaces, storage devices, and/or other components. Any and/or all of the computing device 1000 and/or the servers 1112, and/or the other devices/systems in the computing environment 1100 may, in some instances, be and/or comprise special-purpose computing devices configured to perform specific functions.

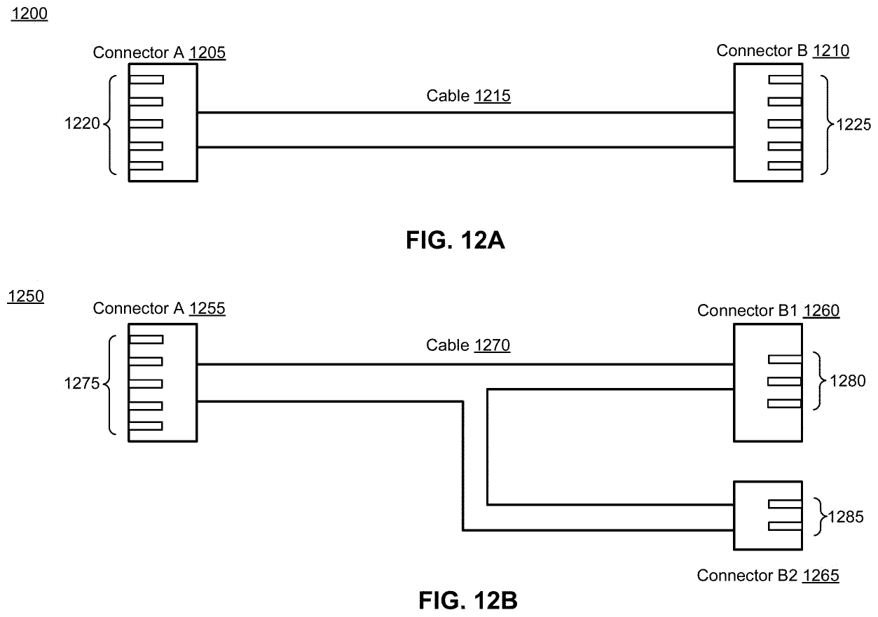

FIGS. 12A and 12B show example cable assemblies, in accordance with one or more example arrangements. FIG. 12A shows an example cable assembly 200 comprising two connectors (e.g., connector A 1205 and connector B 1210) linked by a cable 1215. Connector A comprises pins 1220 and connector B comprises pins 1225. The quantity of pins 1220 may or may not be equal to the quantity of pins 1225. A cable assembly may comprise more than one connector one each end of the cable. FIG. 12B shows an example cable assembly 1250 with three connectors. Pins 1275 at connector A 1255 may be connected, via the cable 1270, to pins 1280 and pins 1285 at connector B1 1260 and connector B2 1265, respectively. For example, a first set of pins, among the pins 1275, may be connected to pins 1280, and a second set of pins, among the pins 1275, may be connected to pins 1285. Although FIG. 12A shows two connectors and FIG. 12B shows three connectors, the disclosure contemplates that an example arrangement in accordance with the computer system disclosed herein may be configured to display any appropriate number of connectors linked with one or more cables and/or interim components. For example, in one embodiment four connectors may be communicatively coupled with a cable wire arranged similar to FIG. 12B, but with an additional branch for a fourth connector.

As further described herein, various parameters of a cable assembly may be defined by a user (e.g., via a graphical user interface (GUI)) as displayed on a user device (e.g., computing device 1000 or client device 1104). For example, the user may configure a length of a cable, a quantity of pins at a connector, a type of a connector, a type of a cable, a mapping between pins at different connectors, etc. The user device or a server may generate 3D models and/or drawings of a cable assembly based on the defined parameters.

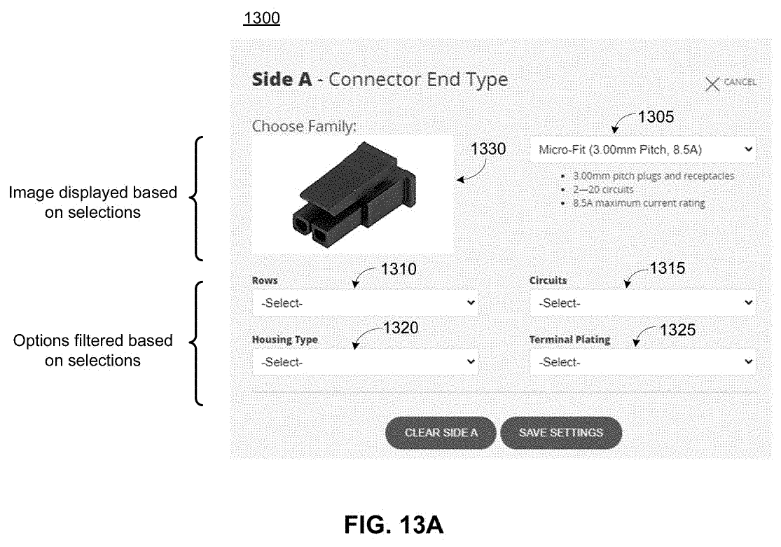

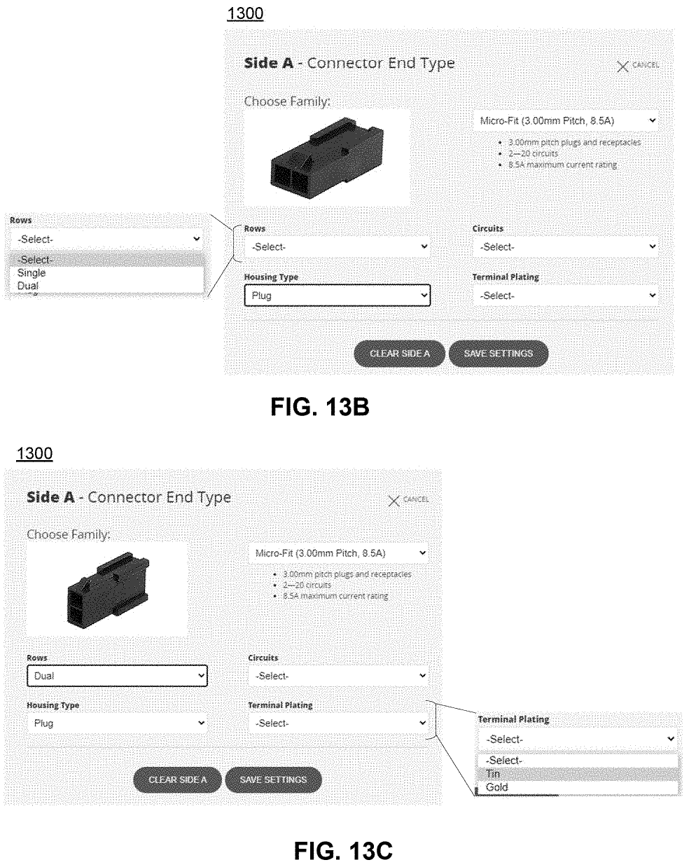

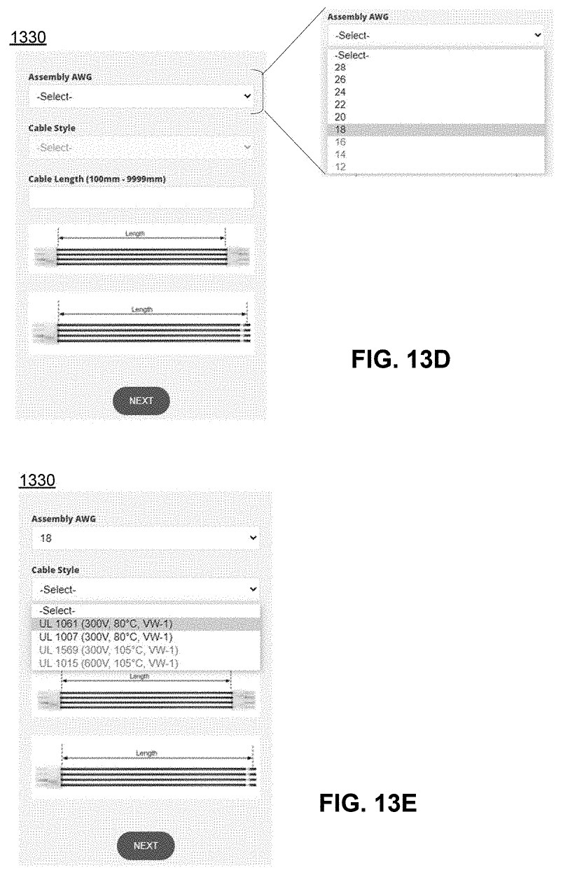

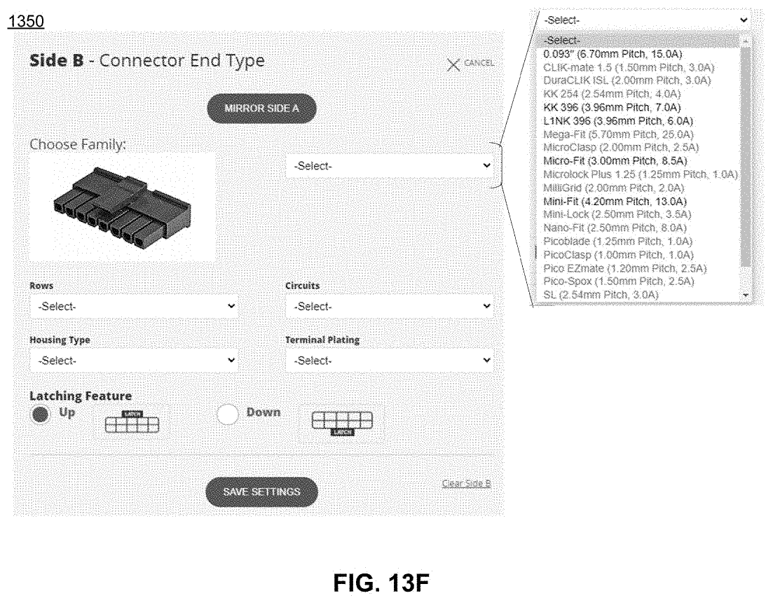

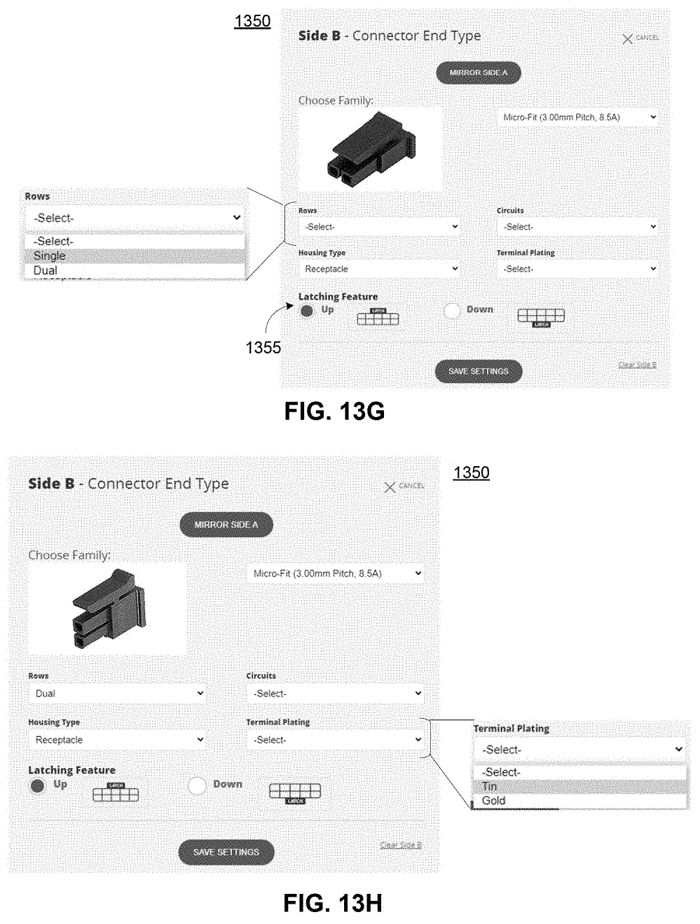

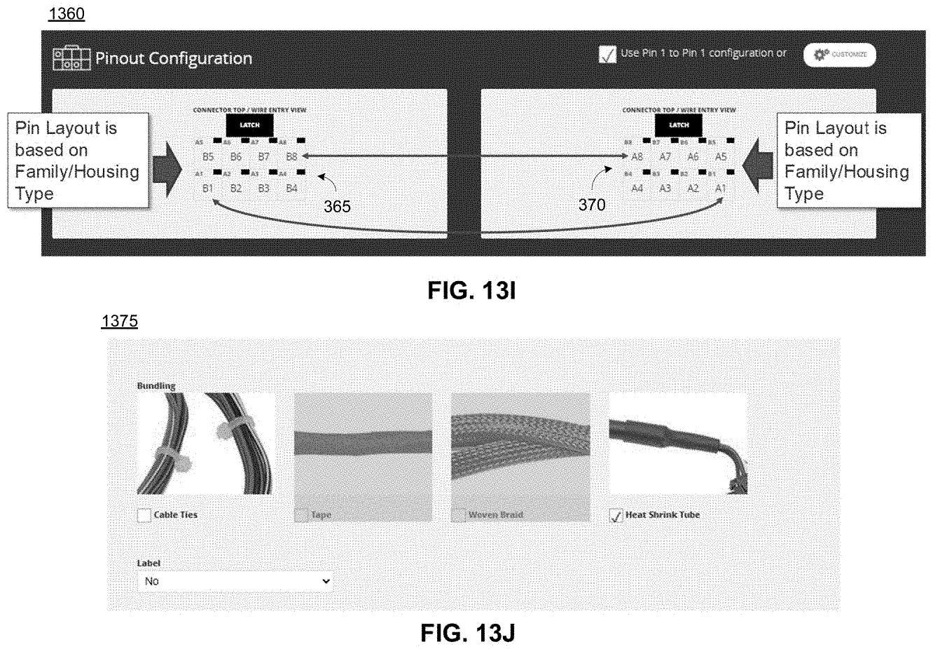

FIGS. 13A-13H show example GUIs at a user device that may be used to input specifications corresponding to a cable assembly. In an arrangement, the example GUIs may correspond to a web application that may accessed at the user device via a uniform resource locator (URL). In another arrangement, the example GUIs may be associated with a software application that may be installed on the user device. The GUIs may be used to input various specifications associated with the connectors and cables in the cable assembly.

FIGS. 13A-13C shows an example GUI 1300 to input information corresponding to a first connector in a cable assembly (e.g., connector A, such as connector A 1205). As shown in FIG. 13A, various parameters associated with the first connector may be input via the GUI 1300. The parameters include a family 1305 of the connector (e.g., MICRO-FIT, CLIK-MATE, DURACLIK, etc.), a quantity of rows 1310 of ports in the connector, a quantity of circuits 1315 associated with the connector, a housing type 1320 (e.g., plug-type or receptacle-type), and/or a terminal plating 1325 (e.g., tin, gold, etc.). Each port may be associated with a corresponding circuit. An image 1330 corresponding to the connector may be displayed based on user input of the parameters.

The GUI 1300 may present multiple options for selection (e.g., via drop-down menus) for each of the parameter. Options that may be available for selection for a particular parameter may be filtered based on selections corresponding to other parameters. For example, a quantity of circuits 1315 that may be selected may depend on a selected family 1305 of the connector and a quantity of rows 1310. For a connector corresponding to the MICRO-FIT connector family with a single row, for example, the quantity of circuits may be limited to a value between 2 and 11. Invalid options in the drop-down menus may be grayed out and/or otherwise made non-selectable within the GUI 1300.

Various GUIs as described with reference to FIGS. 13A-13H may present options for selection based on a client-side scripting code as being executed by processors associated with a user device. A JAVASCRIPT code (or any other client-side scripting code) executing on the user device may filter options being presented via the GUIs based on selections corresponding to other parameters. The JAVASCRIPT code may validate user selections to ensure that the parameters selected are valid (e.g., are compatible with other parameters as selected for the cable assembly).

FIGS. 13B and 13C shows selection of other parameters, associated with the first connector in the cable assembly, via the GUI 1300. FIG. 13B shows an example selection of a quantity of rows for the first connector. For example, a connector corresponding to the MICRO-FIT connector family with plug-type housing may be configured with a single row or dual rows. FIG. 13C shows an example selection of a terminal plating for the first connector. For example, a connector corresponding to the MICRO-FIT connector family may be configured with gold or tin terminal plating.

FIGS. 13D and 13E shows an example GUI 1330 to input information corresponding to a cable in the cable assembly (e.g., cable 1215 as shown in FIG. 12A). The GUI 1330 may be displayed at the user device following user selection of parameters associated with the first connector via the GUI 1300. Available options associated with the cable may be filtered based on other selections (e.g., selections made for the first connector as shown in FIGS. 13A-13C). FIG. 13D shows an example selection of a wire gauge (e.g., American wire gauge (AWG)) for conductors used in the cable. The GUI 1330 may display AWGs available for selection (AWGs 18, 20, 22, 24, 26, and 28), for example, based on the selection of the MICRO-FIT connector family (e.g., as shown in FIG. 13A). FIG. 13E shows an example selection of a cable style corresponding to the cable. Different cable styles may correspond to different operating voltages and/or temperatures. The GUI 1330 may also be used to input a length of the cable

FIGS. 13F-13H shows an example GUI 1350 to input information corresponding to a second connector in the cable assembly (e.g., connector B, such as connector B 1210). The GUI 1330 may be displayed at the user device following user selection of parameters associated with the first connector (via the GUI 1300) and/or user selection of parameters associated with the cable (via the GUI 1330). Similar to the first connector, various parameters (e.g., connector family, quantity of rows, quantity of circuits, housing type, terminal platting, etc.) associated with the second connector may be defined. Options that may be available for selection for a particular parameter may be based on parameters input via the GUI 1300. For example, based on the selection of the MICRO-FIT connector family via the GUI 1300 (e.g., as shown in FIG. 13A), the available options for a connector family of the second connector may be—0.093″, KK 396, LINK 396, MICRO-FIT, and MINI-FIT. Connector families that are incompatible with the MICRO-FIT connector (e.g., CLIK-MATE, DURACLIK, etc.) may be grayed out and/or otherwise made non-selectable within the GUI 1350.

Additionally, and as described with reference to FIGS. 13A-13C, options that may be available for selection for a particular parameter of the second connector may be filtered based on selections corresponding to other parameters of the second connector. FIGS. 13G and 13H shows selection of other parameters, associated with the second connector in the cable assembly, via the GUI 1350. FIG. 13G shows an example selection of a quantity of rows for the first connector. For example, a connector corresponding to the MICRO-FIT connector family with plug-type housing may be configured with a single row or dual rows. FIG. 13H shows an example selection of a terminal plating for the second connector. For example, a connector corresponding to the MICRO-FIT connector family may be configured with gold or tin terminal plating. A latching feature of the second connector may be oriented above or below the ports of the second connector. The GUI 1350 may be used to select an orientation of the latching feature using the radio buttons 1355.

FIG. 13I shows an example GUI 1360 to define a pinout configuration for the first connector and the second connector. The pinout configuration may specify the ports in the first connector that connect to the ports in the second connector. Port layouts at the first connector and the second connector may be based on the selected connector families and/or housing types. A port layout 1365 at the first connector may be different from a port layout 1370 at the second connector. For example, a first port of the first connector (e.g., port A1) may be at the bottom left of the first connector, while a first port of the second connector (e.g., port B1) may be at the bottom right of the second connector.

A user may select a “1-to-1 mapping” where a port at the first connector is connected to a port with a same port number at the second connector. For example, port 1 (e.g., port A1) at the first connector may be connected to port 1 (e.g., port B1) at the second connector, port 2 (e.g., port A2) at the first connector may be connected to port 2 (e.g., port B2) at the second connector, etc. Alternatively, a user may manually select the ports at the first connector and the second connector that are to be linked. FIG. 13J shows an example GUI 1375 that may be used to define a bunding type to be used for the cable assembly. The GUI 1375 may also be used to set a label for the cable assembly.

The user device may generate a data file (e.g., comma separated value file) comprising the user selected parameters (e.g., as described with reference to FIGS. 13A-13J). Alternatively, in an arrangement wherein a web application (e.g., accessible via a URL) is used to input the parameters, a web server associated with the web application may generate the data file. The data file may be stored to a database (e.g., database 1132). The data file may be used to translate the parameters, as configured by a user, for a cable configurator system (e.g., an NX cable configurator system or other cable configurator system). In an arrangement, the cable configurator system may comprise a custom automation background application (e.g., an NX automation background application/thread or other automation background application/thread) that may generate 3D models and drawings in accordance with various examples described herein.

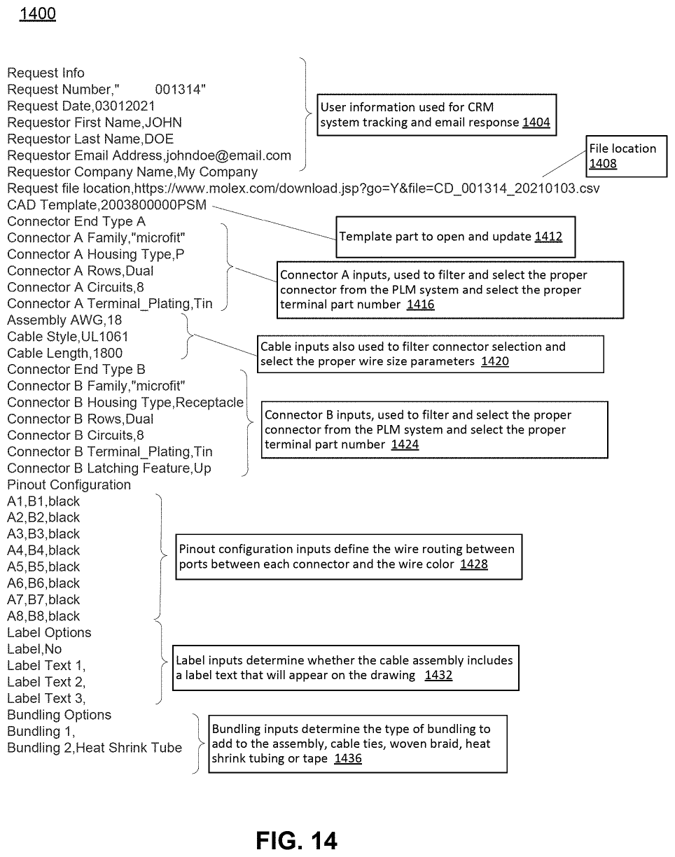

FIG. 14 shows an example data file as generated by the user device or a web server based on user input via GUIs, in accordance with one or more example arrangements. The example data file may indicate cable inputs comprising one or more of user information 1404, a location 1408 of the data file, a template part indicator 1412, connector A inputs 1416, cable inputs 1420, connector B inputs 1424, a pinout configuration inputs 1428, label inputs 1432, and/or bundling inputs 1436. The generated data file may be moved to a secure database that may be accessed by a cable configurator application. In one example, a template part indicator 1412 is based on specifications entered by the user and received by a graphical user interface of the system. The template (e.g., CAD template) may be determined by which cable assembly is being defined. For example, with a two-connector configuration, which is one-to-one, a configuration/CAD template may comprise a defined range of AWGs/cable styles and particular sets of connectors families. In another example, a configuration/CAD template may be configured with a different two-connector configuration with different AWG and cable styles and/or connector family requirements. The disclosure contemplates N-to-N connector configurations with different CAD/configuration templates based on connector layout patterns (e.g., a×layout, a+layout, or other layouts).

User information 1404 may be input at a user device along with the cable assembly specifications. The location 1408 may indicate a path associated with the data file as stored in a database. The template part identifier 1412 may indicate a cable assembly template that is to be used for generation of the specified cable assembly. The cable assembly template may correspond to CAD/CAM application. For example, if the CAD/CAM application is SIEMENS NX, the cable assembly template may be an NX template part, in one example.

The connector A inputs 1416 may indicate a family of the connector, a housing type of the connector, a quantity of rows of the connector, a quantity of circuits for the connector, and/or terminal plating for the connector. The cable inputs 1420 may indicate a wire gauge of the cable, a cable style corresponding to the cable, and/or a cable length corresponding to the cable. The connector B inputs may indicate a family of the connector, a housing type of the connector, a quantity of rows of the connector, a quantity of circuits for the connector, and/or terminal plating for the connector. The pinout configuration inputs 1428 may indicate a mapping/routing between ports associated with connector A and ports associated with connector B. The pinout configuration inputs 1428 may further indicate colors associated with wires connecting the ports. The label inputs 1432 may indicate label text that is to be used in the drawing of the cable assembly. The bundling inputs 1436 may indicate the type of bundling to be used for the assembly (e.g., cable ties, woven braid, heat shrink tubing, tape, etc.).

A cable configurator application (e.g., executed at a user device or a server) may be used to generate cable assembly models (and other associated files and/or data) based on the generated data file. The application may read and parses the data file to determine the cable assembly inputs. A CAD template model/part may be determined based on an indication in the data file, downloaded from a database (e.g., associated with an SAP product lifecycle management (PLM) system), and opened in a background session (e.g., associated with a CAD/CAM application). The application may, based on the cable assembly inputs, determine various model parameters (e.g., NX parameters or other parameters). The application may further, based on the model parameters, add connectors and update CAD template model parameters (e.g., associated with the CAD template model) to generate the cable assembly.

Programming logic within the CAD template model parameters may use the model parameters to filter and select the matching connector part numbers from connector tables. The application may then download the connector parts from the database (e.g., associated with the SAPPLM system), and add the connector parts to the CAD template. Model parameters that define connector dimensions and connector port sequencing for the connector may be determined based on the connector tables. Next, the application may read in wire pinout configuration/color (e.g., as indicated in the input parameters) into the model parameters. Using the model parameters that define connector ports and dimensions, the programming logic within the CAD template model parameters may route the wire geometry between the connector ports and assigns the color to the wire geometry. The application may further use additional model parameters to create the bundling geometry in the CAD template model.

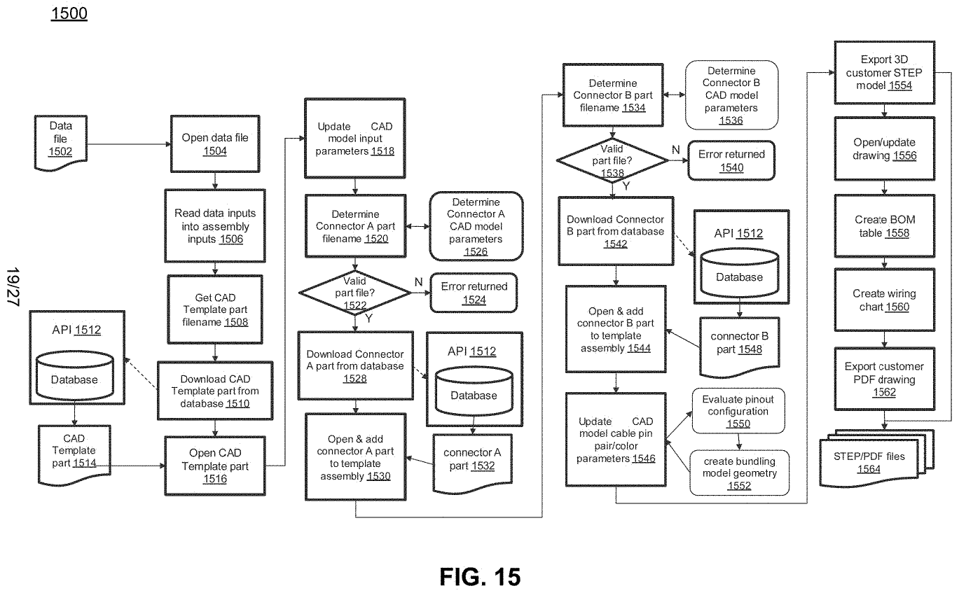

After the CAD template model is updated, the application may generate a 3D digital model file (e.g., a .stp file, or a 3D data file corresponding to any other format). The application may additionally generate a 2D customer drawing, a bill of materials, and/or the wiring chart. The program stores the generated files in a database that may be accessed by the user device and/or the server. FIGS. 15-20 describe additional details associated with operation of the cable configurator application.

FIG. 15 shows an example method for generation of cable assembly models, in accordance with one or more example arrangements. While the example method 1500 is described with reference to a server computer (e.g., the server 1112), in other examples, one or more operations of the method 1500 (or the entirety of the method 1500) may be implemented at a user device (e.g., the computing device 1000, or the client device 1104).

The server may execute a cable configurator application to generate the cable assembly model, drawings, and/or other files based on a data file (e.g., data file as described with reference to FIG. 14). The cable configurator application may be an automation background thread that runs in a background of a CAD/CAM application, and that may interface with the CAD/CAM application for generating cable assembly models.

At step 1504, the server may access the data file 1502 (e.g., a character delimited file, such as a CSV file). The data file 1502 may be generated based on user input and may comprise information as described with reference to the data file 1400 in FIG. 14. At step 1506, the server may read parameters (e.g., inputs) corresponding to the data file 1400 and use them as inputs for the generation of the cable assembly model.

The automation background thread may be associated with an API library 1512 (e.g., an NX API library or other API library). The API library 1512 may further comprise a database (e.g., associated with an SAP PLM system) with one or more CAD template part files. At step 1508, the automation background thread may determine a CAD template part filename based on the template part indicator indicated by the data file. For example, with reference to the data file 1400, the CAD template part file may be “2003800000PSM.” The server may use the automation background thread to retrieve the CAD template part file 1514, and further, at step 1516, open/access (e.g., using the CAD application) a CAD template assembly corresponding to the CAD template part file 1514.

The CAD template part file may include a plurality of CAD model parameters that may be used to generate a cable assembly model. The CAD model parameters may be determined based on model input parameters and data parameters. The model input parameters may be determined based on inputs at the user device (e.g., via GUIs as described with reference to FIGS. 13A-13J). The data parameters may comprise table records comprising pre-validated combinations of housing type, terminal plating, cable styles, quantity of rows, and quantity of connector circuits that may be used by each connector family. The data parameters may further include programming logic to manipulate/update the CAD model parameters and modify/update model geometry based on the CAD model parameters.

At step 1518, the automation background thread may update the CAD model input parameters based on cable assembly inputs (e.g., as received from the user device). The automation background thread may use the programming logic to update the CAD model input parameters. For example, the CAD model input parameters may be updated based on the connector A inputs 1416, connector B inputs 1424, the cable inputs 1420, and/or other inputs described with reference to FIG. 14. The CAD model input parameters may comprise connector A model input parameters (e.g., connector A inputs 1416), connector B model input parameters (e.g., connector B inputs 1424), pin pair and wire color model input parameters (e.g., pin configuration inputs 1428), etc. As further described herein, the CAD model input parameters may be used to determine the CAD model parameters associated with the CAD template assembly. The automation background thread may be used to validate the CAD model input parameters and, based on the validation, determine the CAD model parameters. Based on the CAD model parameters, the CAD application may update the CAD template assembly to generate a CAD model corresponding to the cable assembly. For example, the input parameters determine which model parameters are to be used for the specific inputs, such as whether a Connector B is required (e.g., Connector B is set to SingleEnd meaning user does not require Connector B). If it is singleEnd, then wire pinouts 1360 are not needed and wires routed accordingly with a 1-N—e.g., pin A1 is routed to Bn and An is routed to B1). Meanwhile, if Connector B is required, then inputs are received corresponding to orientation, bundling option, and other bundling parameters. In some examples, if an error occurs in the input parameters, if inputs are missing in the input file, or if the input model parameters receive an invalid or missing input, then the process returns an error message to the server process.

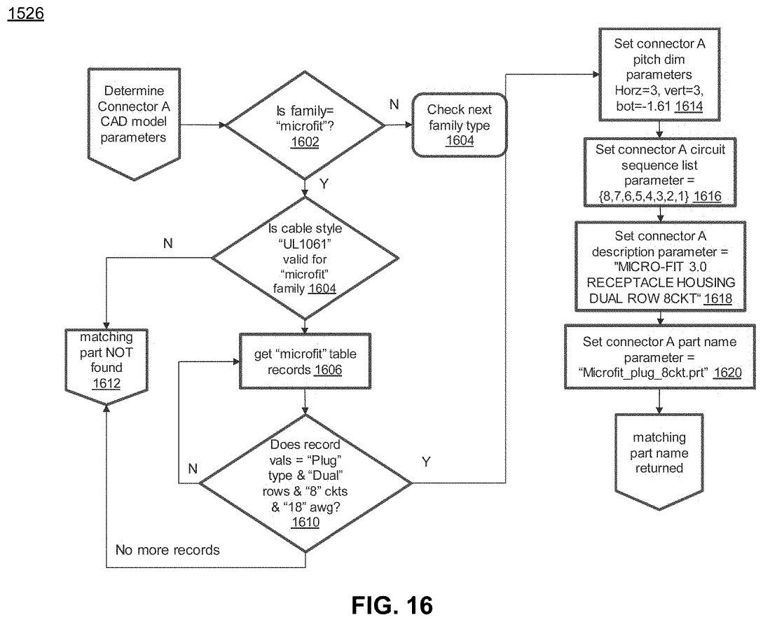

At step 1526, the automation background thread may determine connector A CAD model parameters based on connector A model input parameters. FIG. 16 shows an example method (e.g., as performed at step 1526) for determining the connector A model parameters. At step 1602, the automation background thread may filter the table records to find a match with a family as indicated in the connector A model input parameters (e.g., connector A inputs 1416). If a family in the table records matches the family indicated in the connector A model input parameters, the automation background thread may further validate other parameters associated with the connector A model input parameters. If a family in the table records does not match the family indicated in the connector A model input parameters, the automation background thread may check the next family type as listed in the table records. For example, as shown in FIG. 14, connector A family is listed in the data file as “microfit.” Therefore, at step 1602, the automation background thread may check if the table records comprise a “microfit” family.

The automation background thread may further use a cable style associated with the cable assembly to filter the table records. At step 1604, the automation background thread may check if a cable style (e.g., as indicated by the cable inputs 1420) is valid for a family indicated in the connector A model input parameters, for example, based on determining that the table record indicates the family. With reference to the cable inputs 1420, the automation background thread may determine if the cable style “UL1061” is a valid selection for the “microfit” model family. The automation background thread may end the process and return an error if the cable style is not valid for the family.

At step 1606, and based on determining that the cable style is valid, the automation background thread may retrieve table records associated with the family (e.g., “microfit”) indicated in the connector A model input parameters. At step 1610, the automation background thread may further validate other parameters associated with connector A model input parameters. For example, the automation background thread may determine if a record comprises other parameters associated with the connector A model input parameters (e.g., a plug type housing, dual rows, 8 circuits, and 18 AWG wires, as indicated by connector A inputs 1416). If a record does not comprise the other parameters, the automation background thread may retrieve a next record in the table records. If the automation background thread checks all records and does not find a match, the automation background thread may end the process and return an error. If a record comprises the other parameters, the automation background thread may select a connector associated with the record as connector A and determine connector A CAD model parameters.

The connector A CAD model parameters may be used for determining the connector A and generating the cable assembly model. One or more parameters associated with the connector A (e.g., pitch dimension parameters, label offset parameter, circuit sequencing configuration option, part number, part description, etc.) may be determined based on the selected connector A. At step 1614, the automation background thread may set connector A pitch dimension parameters based on the selected connector A. At step 1616, the automation background thread may set a connector A circuit sequence list parameter based on the pinout configuration inputs 1428. In one example, the sequence list parameter is based on the selected connector, not the pinout configuration inputs. At step 1620, the automation background thread may set a connector A description parameter based on the selected connector A. At step 1620, the automation background thread may set a connector A part name parameter based on the selected connector A. Returning to FIG. 15, at step 1520, the automation background thread may determine connector A part file name based on the connector A part name parameter.

At step 1524, if the automation background thread does not find a connector corresponding to the connector A model input parameters, the automation background thread may end the process and return an error. At step 1528, if the automation background thread finds a connector corresponding to the connector A model input parameters, the automation background thread may download a connector A part file 1532 from the database (e.g., associated with the SAP PLM system). The automation background thread may download the connector A part file 1532 based on the connector A part name parameter. At step 1530, the automation background thread may add the connector A part (e.g., corresponding to the connector A part file 1532) to the CAD template assembly as opened in the CAD application.

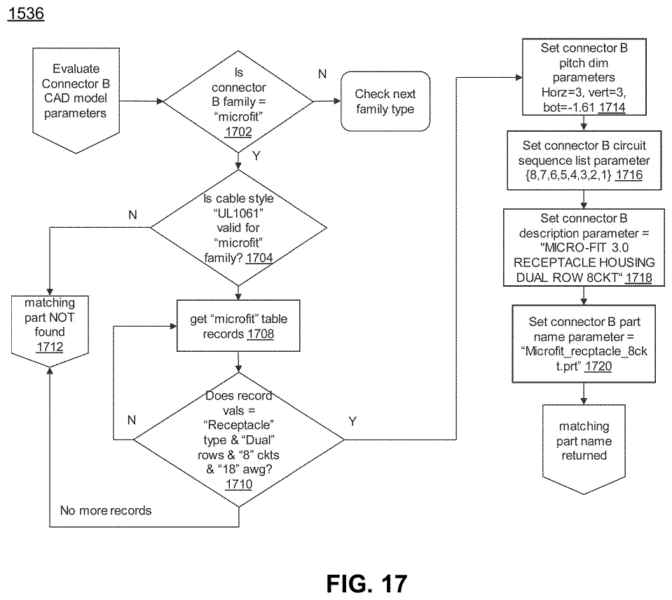

The automation background thread may perform steps similar to steps 1520-1530 for connector B. At step 1536, the automation background thread may determine connector B CAD model parameters. For example, as shown in FIG. 17, and in a similar manner as described with reference to connector A in FIG. 16, the automation background thread may scan table records to validate connector B model input parameters. If a record matches the connector B model input parameters, the automation background thread may select a connector associated with the record as connector B and determine the connector B CAD model parameters. For example, the automation background thread may determine connector B pitch dimension parameters, connector B sequence list parameter, connector B description parameter, connector B part name parameter, etc. At step 1534, the automation background thread may determine connector B part name based on the connector B part name parameter.

At step 1540, if the automation background thread does not find a connector corresponding to the connector B model input parameters, the automation background thread may end the process and return an error. At step 1542, if the automation background thread finds a connector corresponding to the connector B model input parameters, the automation background thread may download a connector B part file 1548 from the database (e.g., associated with the SAP PLM system). The automation background thread may download the connector B part file 1548 based on the connector B part name parameter. At step 1544, the automation background thread may add the connector B part (e.g., corresponding to the connector B part file 1548) to the CAD template assembly as opened in the CAD application.

After connector A and connector B are added to the CAD template assembly, the application background thread may use other inputs (as indicated in the data file) to update other parameters of the CAD template assembly (e.g., CAD model parameters corresponding to wiring between ports associated with the connectors, cable bundling, etc.). The updated parameters may be used to generate a CAD model of the cable assembly (e.g., by the CAD application). For example, the application background thread may use the pinout configuration inputs 1428 to determine the wiring between the ports and colors associated with the wires. The application background thread may further use the bundling inputs 1436 to determine bundling types used for a cable between the connectors.

The automation background thread may read pinout configuration inputs (e.g., the pinout configuration inputs 1428) into the pin pair and wire color model input parameters. At step 1546, the automation background thread may determine/update the CAD model cable pin pair/color parameters, for example, based on the pin pair and wire color model input parameters). Determining the CAD model pin pair parameters may comprise determining the pinout configuration (e.g., at step 1550). The CAD application may use the CAD model cable pin pair/color parameters in the CAD template assembly to generate a CAD model corresponding to the cable assembly.

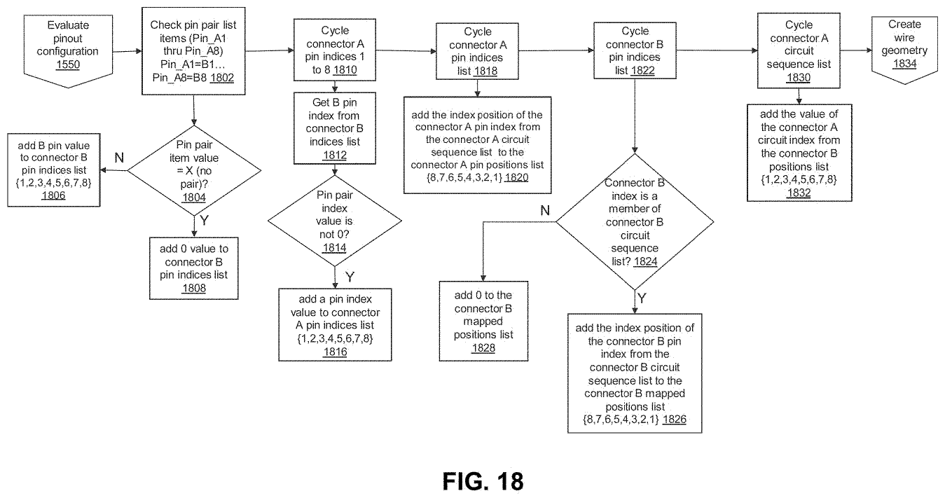

FIG. 18 shows further details associated with a procedure for determining the pinout configuration. The pinout configuration may be determined based on pin pair list items (e.g., as indicated in pinout configuration inputs 1428). The automation background thread may determine the connector A pin indices list (e.g., step 1816) and connector B pin indices list (e.g., steps 1806 and 1808).

The connector B pin indices list model parameter may be determined by checking each pin pair model parameter and getting the connector B pin number. For example, if Pin_A1=B1 then 1 is returned, if Pin_A1=B8 then 8 is returned, if Pin_A1=X (meaning the no wire pair for pin A1) then 0 is returned.

The connector A pin indices list model parameter may be comprised of the connector A pins that are paired with a corresponding connector B pin. The automation background thread may also check whether a connector B pin index value is non-zero for the current pin A index. For example, for pin A indices 1 to 8 and for each value in the connector B pin indices list, if the value is not 0, the A pin index value is returned.

The connector A pin positions CAD list model parameter is determined by mapping the connector A pin indices to the connector A circuit sequence list model parameter. The connector B pin positions list model CAD parameter is determined by mapping the connector B pin indices to the connector B circuit sequence list model parameter.

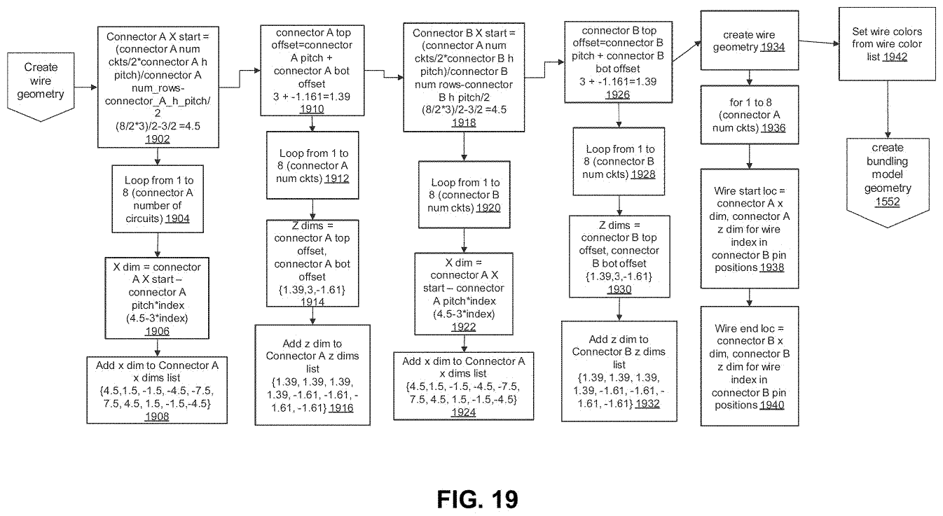

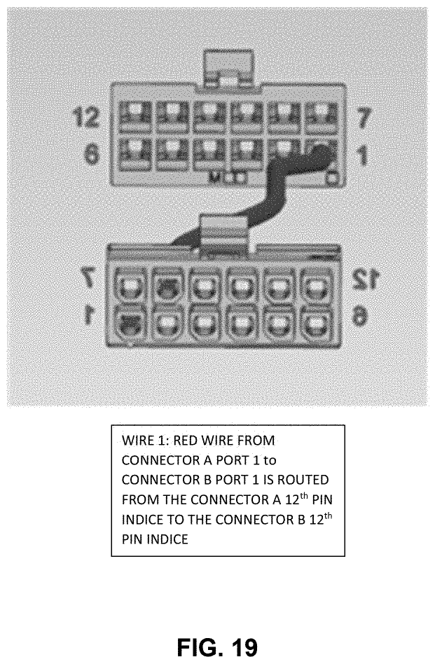

Once the pin positions are derived, the CAD wiring geometry may be created using connector A pin positions list and connector B pin positions list CAD model parameters, as shown in FIG. 19A. CAD datum coordinate systems may define the location of each connector. The connector B datum location may be offset from connector A by the cable length CAD model parameter. First, the CAD model parameters that define the connector A pin locations may be determined from the connector A dimensions, number of circuits and numbers of rows CAD model parameters. The pin locations may be offset from the main connector datum.

Next, the CAD model parameters that define the connector B pin locations may be determined from the connector A dimensions, number of circuits, and number of rows CAD model parameters. The pin locations may offset from the main connector datum.

Each cable wire geometry may be created based on whether the wire pin index is a member of the connector A pin positions list model parameter. The starting pin position is read from the connector A pin locations list CAD model parameter based on the wire pin position. For example, with reference to FIG. 19B, the starting location for wire 1 may be the 12^{th} location in the pin connector A positions list CAD model parameter. The end pin position may be determined by getting the value of the wire number at the current pin indices and then reading the connector B pin position from the connector B pin position list CAD model parameter for that wire number.

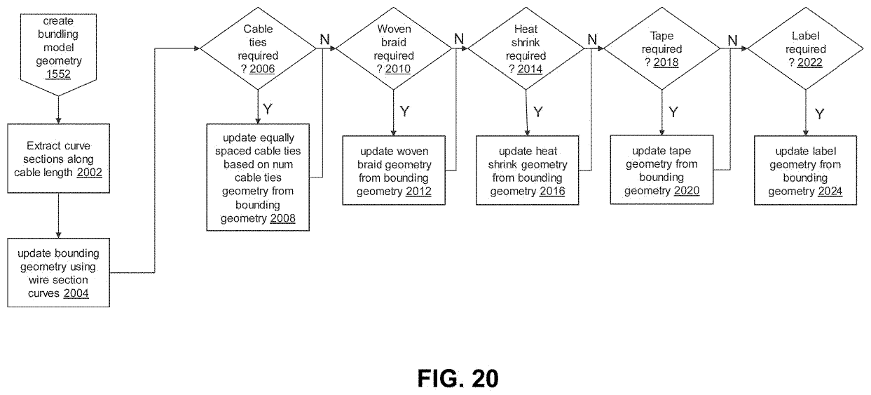

At step 1552, the automation background thread may use the bundling inputs 1436 to create the bundling geometry in the CAD template assembly, as shown in FIG. 20. The wire bundling geometry may be derived by determining section geometry at intervals along the cable assembly and generating the bounding geometry through the sections (e.g., steps 2002 and 2004). The automation background thread may further update additional details associated with the CAD template assembly (e.g., cable ties, braids, heat shrink tubing, tape, labels, etc.) bundling inputs 1436 (e.g., steps 2006-2024). Label inputs 1432 may be used to determine label text to be used for drawings associated with the generated CAD model of the cable assembly.

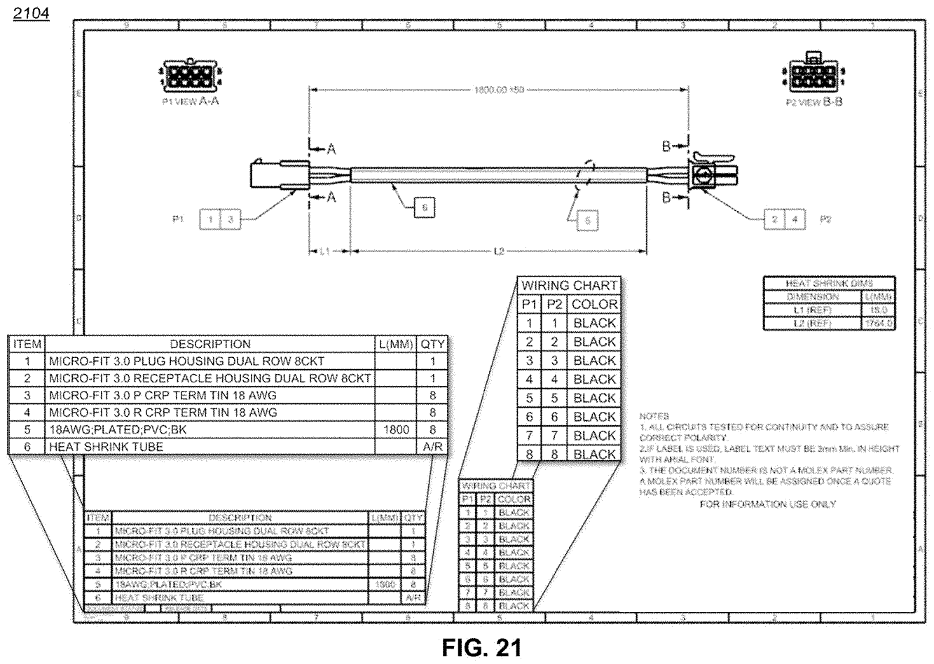

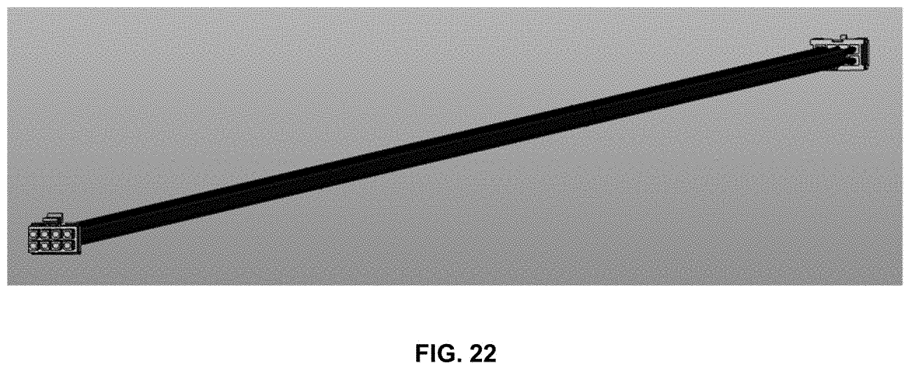

At step 1554, the CAD application may generate and/or export a 3D digital model file (e.g., a .stp file, or a file corresponding to any other format that may store 3D data) based on the generated CAD model. At step 1556, the CAD application may open/update a 2D drawing associated with the 3D digital model file. The CAD application may generate and include a BOM table and a wiring chart on the 2D drawing (e.g., steps 1558 and 1560). Once the drawing is created and updated, the automation background thread may generate a document (e.g., a PDF document) of the drawing (e.g., step 1562). The 2D drawing file and the 3D digital model file may be exported to a database that may be accessed by the server. FIG. 21 shows an example 2D drawing 2104 with an included BOM table 2108 and wiring chart 2112. FIG. 22 shows an example graphical rendering of the 3D digital model as generated by the CAD application. The 3D digital model file, the graphical rendering, and/or the 2D drawing may be sent, by the server, to the user device for review.

Additionally, or alternatively, the 3D digital model file, the graphical rendering, and/or the 2D drawing may be sent to a server (or any computing device) associated with a manufacturing facility. The 3D digital model file may be used for fabrication of the cable assembly.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure. Furthermore, the phraseology and terminology used herein are for the purpose of description and should not be regarded as limiting. Rather, the phrases and terms used herein are to be given their broadest interpretation and meaning. For example, the use of “including” and “comprising” and variations thereof is meant to encompass the items listed thereafter and equivalents thereof as well as additional items and equivalents thereof. Moreover, the use of “user” and “customer” may be used interchangeably in the disclosure and is meant to broadly encompass a person or entity that interacts with the described system regardless of whether that person or entity is an existing customer, prospective customer, or some other type of non-customer user (e.g., internal tester, salesperson, etc.).

I/We claim:

1. A method for generating, in near real-time, a graphical rendering of a cable assembly product on a computer display by filtering and validating the cable assembly product, the method comprising:
receiving, at a server device and from a user client device, a selection of parameters for the cable assembly product in a character delimited input file, wherein the selection of parameters indicates:
a computer aided design (CAD) template assembly;
connector family selections corresponding to connectors of the cable assembly product;
parameters associated with the connectors of the cable assembly product; and
a cable style selection for the cable assembly product;
executing, by the server device, an automation background thread configured to validate, in near real-time, the selection of parameters, wherein the automation background thread:
determines a CAD template assembly;
based on the connector family selections and the cable style selection indicated in the character delimited input file, filters table records indicating pre-validated connectors corresponding to a plurality of connector families, to determine filtered table records;
scans the filtered table records to find matched table records that match the parameters associated with the connectors of the cable assembly product; and
determines, based on the matched table records, model parameters associated with each connector;
generating, by the server device, based on the CAD template assembly and the model parameters associated with the connectors, a digital model of the cable assembly product; and
generating, by the server device and based on the digital model of the cable assembly product, a graphic design file of the cable assembly product to display on the user client device.

2. The method of claim 1, wherein generating the digital model of the cable assembly product comprises:
retrieving, from a memory associated with the server device and based on the model parameters associated with the connectors, connector part files; and
adding the connector part files to the CAD template assembly.

3. The method of claim 1, wherein:
the selection of parameters for the cable assembly product further indicate parameters associated with a cable connecting the connectors of the cable assembly product;
the automation background thread determines model parameters associated with the cable based on the parameters associated with the cable; and
generating the digital model of the cable assembly product comprises generating the digital model of the cable assembly product further based on the model parameters associated with the cable.

4. The method of claim 3, wherein the model parameters associated with the cable indicate:
a wire geometry associated with the cable;
a pin pair configuration between pins corresponding to the connectors; and
a bundling geometry associated with the cable.

5. The method of claim 1, wherein the selection of parameters is validated at the user client device by a client-side scripting code executing on the user client device.

6. The method of claim 1, further comprising, sending, by the server device to the user client device, the graphic design file of the cable assembly product.

7. The method of claim 1, further comprising generating, by the server device, a bill of materials (BOM) for the cable assembly product.

8. The method of claim 7, further comprising sending, by the server device to a computing device associated with a manufacturing facility, the graphic design file and BOM for assembly and shipping of the cable assembly product.

9. The method of claim 1, wherein the graphic design file comprises a three-dimensional model file of the cable assembly product.

10. The method of claim 1, wherein the graphic design file comprises a two-dimensional image file of the cable assembly product.

11. A system for generating, in near real-time, a graphical rendering of a cable assembly product on a display by filtering and validating the cable assembly product, the system comprising:
a user device comprising a memory storing computer-readable instructions that, when executed by an at least one processor of the user device, cause the user device to:
receive, via a graphical user interface (GUI) on a display associated with the user device, a selection of parameters for a cable assembly product in a character delimited input file, wherein the selection of parameters indicates:
a computer aided design (CAD) template assembly,
connector family selections corresponding to connectors of the cable assembly product,
parameters associated with the connectors of the cable assembly product, and
a cable style selection for the cable assembly product;
generate, based on the selection of parameters, a character delimited input file; and
send, to a server device, the character delimited input file; and
the server device comprising a memory storing computer-readable instructions that, when executed by an at least one processor of the server device, cause the server device to:
execute, an automation background thread configured to validate, in near real-time, the selection of parameters, wherein the automation background thread:
determines a CAD template assembly;
based on the family selections and the cable style selection indicated by the character delimited input file, filters table records, indicating pre-validated connectors corresponding to a plurality of connector families, to determine filtered table records;
scans the filtered table records to find matched table records that match the parameters associated with the connectors of the cable assembly product; and
determines, based on the matched table records, model parameters associated with each connector;
generate, based on the CAD template assembly and the model parameters associated with the connectors, a digital model of the cable assembly product; and
generate, based on the digital model of the cable assembly product, a graphic design file of the cable assembly product.

12. The system of claim 11, wherein the second computer-readable instructions, when executed cause generating the digital model of the cable assembly product by causing:
retrieving, from the second memory and based on the model parameters associated with the connectors, connector part files; and
adding the connector part files to the CAD template assembly.

13. The system of claim 11, wherein:
the selection of parameters for the cable assembly product further indicate parameters associated with a cable connecting connectors of the cable assembly product;
the automation background thread determines model parameters associated with the cable based on the parameters associated with the cable; and
the second computer-readable instructions, when executed cause generating the digital model of the cable assembly product by causing generating the digital model of the cable assembly product further based on the model parameters associated with the cable.

14. The system of claim 13, wherein the model parameters associated with the cable indicate:
a wire geometry associated with the cable;
a pin pair configuration between pins corresponding to the connectors; and
a bundling geometry associated with the cable.

15. The system of claim 13, wherein the GUI comprises a client-side scripting code executing on the user device configured to:
receive the selection of parameters, and
validate the selection of parameters.

16. The system of claim 15, wherein the client-side scripting code is configured to validate the selection of parameters by filtering parameter options, presented on the GUI, based on user selection of one or more other parameters.

17. A tangible computer-readable medium storing computer-executable instructions that, when executed by a processor, cause:
receiving, from a user client device, a selection of parameters for a cable assembly product in a character delimited input file, wherein the selection of parameters indicates:
a computer aided design (CAD) template assembly;
connector family selections corresponding connectors of the cable assembly product;
parameters associated with the connectors of the cable assembly product; and
a cable style selection for the cable assembly product;
executing an automation background thread configured to validate, in near real-time, the selection of parameters, wherein the automation background thread:
determines a CAD template assembly,
based on the family selections and the cable style selection indicated in the character delimited input file, filters table records indicating pre-validated connectors corresponding to a plurality of connector families, to determine filtered table records,
scans the filtered table records to find matched table records that match the parameters associated with the connectors of the cable assembly product; and
determines, based on the matched table records, model parameters associated with each connector;
generating, based on the CAD template assembly and the model parameters associated with the connectors, a digital model of the cable assembly product; and
generating, based on the digital model of the cable assembly product, a graphic design file of the cable assembly product to display on the user client device.

18. The tangible computer-readable medium of claim 17, wherein the instructions, when executed by the processor, cause generating the digital model of the cable assembly product by causing:
retrieving, from a memory and based on the model parameters associated with the connectors, connector part files; and
adding the connector part files to the CAD template assembly.

19. The tangible computer-readable medium of claim 17, wherein:
the selection of parameters for the cable assembly product further indicate parameters associated with a cable connecting connectors of the cable assembly product;
the automation background thread determines, based on the parameters associated with the cable, model parameters associated with the cable; and
the instructions, when executed by the processor, cause generating the digital model of the cable assembly product by causing generating the digital model of the cable assembly product further based on the model parameters associated with the cable.

20. The tangible computer-readable medium of claim 19, wherein the model parameters associated with the cable indicate:
a wire geometry associated with the cable;
a pin pair configuration between pins corresponding to the connectors; and
a bundling geometry associated with the cable.
